(19) United States
(12) Patent Application Publication
(10) Pub. No.: US 2010/0082702 A1
(43) Pub. Date: Apr. 1, 2010

(54) DYNAMIC VEHICLE INFORMATION MANAGEMENT

(75) Inventors: Jijji Ramanathan, Bangalore (IN); Mohamed Siddique, Bangalore (IN); Brayan Pais, Bangalore (IN); Vidhyashankaran Ramamoorthy Iyer, Bangalore (IN)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/240,440

(22) Filed: Sep. 29, 2008

(51) Int. Cl. G06F 17/30

(52) U.S. Cl. 707/803; 707/E17.005

(57) ABSTRACT

A method for dynamically managing data changes to a vehicle health monitoring system (VHM) by a datacenter using an external agent is provided. The external agent is operational on, or in communication with, a vehicle. One of updating or modifying a vehicle configuration file is performed to add or delete vehicle information on the vehicle configuration file by the external agent. A dummy file is created on a disk by the external agent. The dummy file provides a signal to the datacenter that the vehicle information on the vehicle configuration file has changed. The disk is polled periodically by the datacenter to identify a presence of the dummy file. Responsive to identifying the presence of the dummy file, the configuration file is read into VHM memory by the datacenter.

### FIELD OF THE INVENTION

The present invention generally relates to vehicle systems, and more particularly, but not exclusively, to dynamic vehicle information management for vehicle health monitoring systems.

### BACKGROUND OF THE INVENTION

Vehicles are used in a variety of settings. For example, aircraft and spacecraft are used in aerospace settings, automobiles, buses, and trains are used in surface settings, and marine vehicles are used on or in marine environments. Telematics, or the integrated use of telecommunications and informatics, also known as information and communications technology (ICT), has become more prevalently used and more important to users and operators of vehicles.

For example, telematics systems may be used in automotive and aircraft navigation systems, logistics, safety communications, and the like. In some cases, a problem may arise that may require troubleshooting and, perhaps, repair of the vehicle. Currently, portions of telematics systems may be used to assist in vehicle health maintenance (troubleshooting and repair). However, these systems lack an ability to dynamically maintain vehicle information. For example, vehicle information may only be read into a telematics system during its boot up cycle. Any new or updated information to be integrated into the system may require a reboot of the system.

Accordingly, a need exists for a method for dynamically maintaining information for vehicle health maintenance systems to help alleviate the current issues described above. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

In one embodiment, by way of example only, a method for dynamically managing data changes to a vehicle health monitoring system (VHM) by a datacenter using an external agent is provided. The external agent is operational on, or in communication with, a vehicle. One of updating or modifying a vehicle configuration file is performed to add or delete vehicle information on the vehicle configuration file by the external agent. A dummy file is created on a disk by the external agent. The dummy file provides a signal to the datacenter that the vehicle information on the vehicle configuration file has changed. The disk is polled periodically by the datacenter to identify a presence of the dummy file. Responsive to identifying the presence of the dummy file, the configuration file is read into VHM memory by the datacenter.

In another embodiment, again by way of example only, a method for dynamically managing data changes to a vehicle health monitoring system (VHM) by a datacenter using an external agent is provided. The external agent is operational on, or in communication with, a vehicle. One of updating or modifying a vehicle configuration file is performed to add or delete vehicle information on the vehicle configuration file by the external agent. A system variable is set to a predefined value by the external agent. The predefined value of the system variable provides a signal to the datacenter that the vehicle information on the vehicle configuration file has changed. The system variable is polled periodically by the datacenter to identify the predefined value. Responsive to identifying the predefined value, the configuration file is read into VHM memory by the datacenter.

In an additional embodiment, again by way of example only, a method for dynamically managing data changes to a vehicle health monitoring system (VHM) by a datacenter using an external agent is provided. The external agent is operational on, or in communication with, a vehicle. One of updating or modifying a vehicle configuration file is performed to add or delete vehicle information on the vehicle configuration file by the external agent. A user-defined signal is sent from the external agent to the datacenter. The user-defined signal includes at least one of a unique process name and identification. The user-defined signal is received in the datacenter. The datacenter identifies the user-defined signal based on the at least one unique process name and identification. Responsive to receiving the user-defined signal in the datacenter, the configuration file is read into VHM memory.

In still an additional embodiment, again by way of example only, a method for dynamically managing data changes to a vehicle health monitoring system (VHM) by a datacenter using an external agent is provided. The external agent is operational on, or in communication with, a vehicle. One of updating or modifying a vehicle configuration file is performed to add or delete vehicle information on the vehicle configuration file by the external agent. A timestamp is recorded on the vehicle configuration file concurrent with the one of updating or modifying the vehicle configuration file. The timestamp is polled periodically by the datacenter to identify a newer time associated with the timestamp. Responsive to identifying the newer time, the configuration file is read into VHM memory.

### BRIEF DESCRIPTION OF THE DRAWINGS

The present invention will hereinafter be described in conjunction with the following drawing figures, wherein like numerals denote like elements, and

FIG. 1 illustrates exemplary dummy file-based signaling;

FIG. 2 illustrates exemplary system variable-based signaling;

FIG. 3 illustrates an exemplary user-defined signal mechanism;

FIG. 4 illustrates exemplary timestamp-based signaling;

FIG. 5 illustrates an exemplary method of dummy file-based signaling;

FIG. 6 illustrates an exemplary method of system variable-based signaling;

FIG. 7 illustrates an exemplary method of signaling incorporating a user-defined signal mechanism;

FIG. 8 illustrates an exemplary method of timestamp-based signaling; and

FIG. 9 illustrates a processing environment in which aspects of the present invention may be implemented.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present description and following claimed subject matter present exemplary method embodiments of a mechanism to dynamically manage vehicle information in a vehicle health monitoring system. The illustrated embodiments implement a variety of signaling methodologies for performing this functionality, including dummy file-based signaling, system variable-based signaling, a user-defined signal mechanism, and timestamp-based signaling.

In each of the illustrated embodiments, an external agent may be configured to be in communication with a datacenter where vehicle information may be stored. The external agent, as well as the datacenter, may be considered a “module” as referenced below. In one embodiment, the external agent may be an application. In another embodiment, the external agent may be a hardware component. The external agent implements a signaling mechanism to communicate with the datacenter.

In similar fashion to the external agent, the datacenter may host an additional application in communication with the application of the external agent. The datacenter may also include one or more hardware components. Through various signaling mechanisms as will be described, the datacenter receives a notification from the external agent that new information/updated information is available. In response to this notification, the datacenter reads the information into memory.

In some embodiments, the signaling mechanisms as will be described may be implemented in conjunction with a service-oriented architecture (SOA) for vehicle telematics platforms. The webservice architecture in conjunction with the SOA acts as an integrated decision support system (DSS) for the vehicle. The DSS, at least partially, functions as a communications network. An enterprise service bus (ESB) may be integrated into the DSS to provide interconnection with external services and functions. The DSS may provide an association of recommended repair actions and/or parts and/or troubleshooting procedures for a received webservice request.

In one exemplary embodiment within an aircraft vehicle setting, the DSS may be implemented to support aircraft maintenance personnel with necessary troubleshooting instructions on a remote basis. Such a scenario may reduce the operating cost of the aircraft.

The DSS may be adapted to follow “webservice”-based communications with the ESB in order to maintain loose coupling, platform independency, and flexibility while interfacing with other services and functions. The DSS may also be adapted to analyze the conditions received from the ESB before processing on the data using onboard decision-making intelligence. This intelligence is facilitated by the inclusion of a DSS core module. The DSS core module may be adapted to perform a variety of specific and flexible functionality. The DSS includes well-defined webservices functions. The DSS may be accessed by any service that is compliant with a web services description language (WSDL), an extensible markup language (XML)-based definitional language.

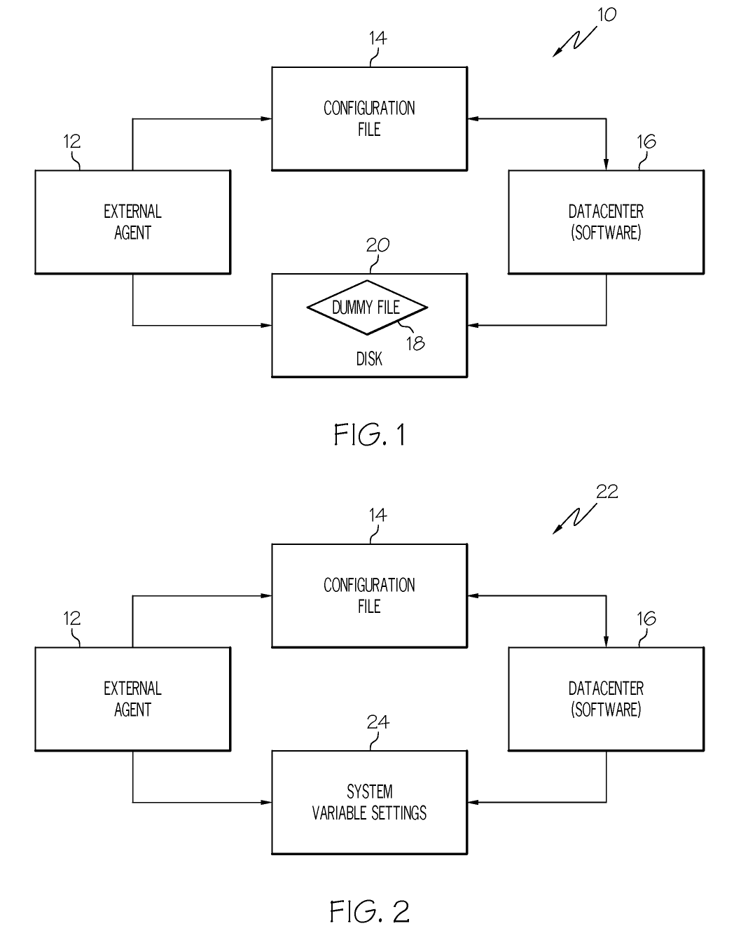

Referring to FIG. 1, a first exemplary signaling mechanism of the present invention is illustrated. The illustrated embodiment utilizes software operational on datacenter hardware, however the skilled artisan will appreciate that hardware, software, firmware, or a combination thereof may be adapted to perform the functionality herein described in relation to the datacenter. As described previously, the datacenter, datacenter software, the external agent, and other components described below may be considered modules.

The exemplary dummy file-based signaling 10 shown utilize an external agent 12. External agent 12 updates or modifies vehicle configuration file 14. Vehicle configuration file 14 maintains vehicle information, including vehicle association information. Datacenter software 16 receives information from a particular vehicle by reading the configuration file 14 for the vehicle.

To implement dummy-file based signaling 10, once the external agent 12 updates or modifies the configuration file 14 to add/delete vehicle information, the external agent 12 creates a dummy file 18 on disk 20 to signal the datacenter software 16 that the configuration file 14 has been updated.

The datacenter software 16 polls the disk 20 on a periodic basis to identify the presence of dummy file 18. Datacenter software deletes the dummy file 18 whenever it locates the dummy file 18 in the disk 20. Whenever the dummy file 18 is identified, the datacenter software 16 reads and reloads the configuration file 14 into VHM memory.

Turning now to FIG. 2, an additional signaling mechanism is illustrated. System variable-based signaling 22 again incorporates external agent 12 in communication with a configuration file 14. Here again, external agent 12 updates or modifies the configuration file 14 to add/delete vehicle information. Once the information is updated in the configuration file 14, the external agent 12 sets a system variable in system variable settings 24 to a predefined value to signal the datacenter software 16 that the configuration file 14 has been updated.

The datacenter software 16 polls the system variable settings 24 including the system variable on a periodic basis to identify the predefined value. If the predefined value is identified, the datacenter software 16 resets the system variable to a value other than the predefined value. The datacenter software 16 reads and reloads the configuration file 14 into VHM memory whenever the predefined value is read.

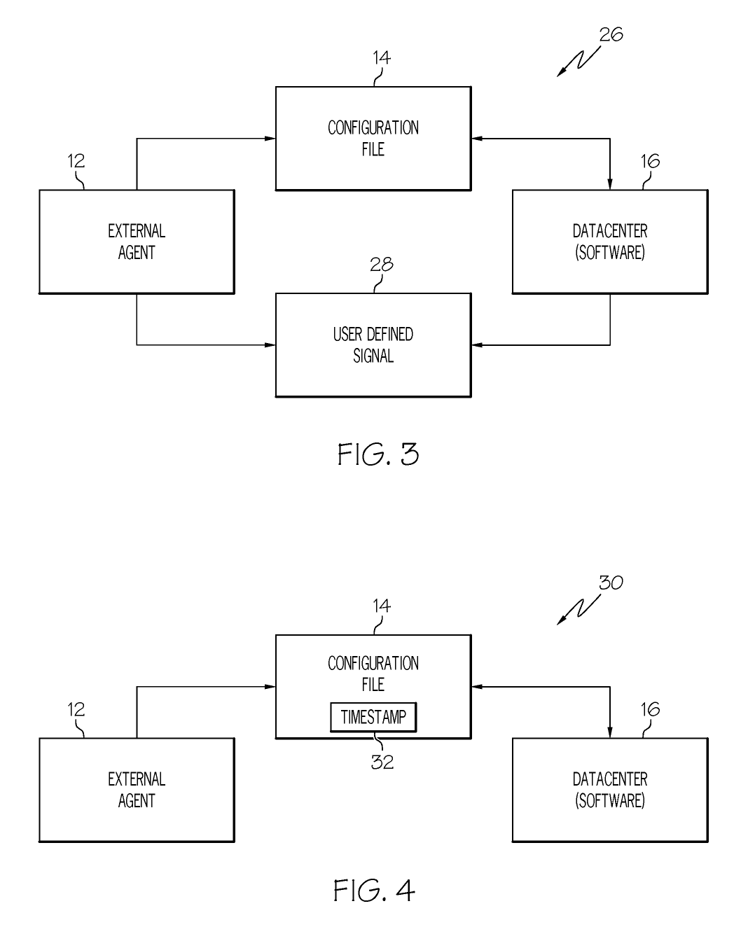

Referring now to FIG. 3, an additional signaling mechanism according to the present invention is illustrated. In the illustrated embodiment, a user-defined signaling mechanism 26 is illustrated. Here again, external agent 12 updates or modifies the configuration file 14 to add/delete vehicle information.

Subsequent to the updating or additional of vehicle information, external agent 12 sends a user-defined signal 28 to the datacenter software 16 with a unique process name and/or identification. The datacenter software 16 identifies the user-defined signal based on the predefined process name/idenification. Whenever the predefined process name/idenfication is read, the datacenter software 16 reads and reloads the configuration file 14 into VHM memory.

FIG. 4 illustrates an additional signaling mechanism according to the present invention. Timestamp-based signaling 30 again incorporates external agent 12 in communication with the configuration file 14. The external agent 12 updates or modifies the configuration file 14 to add/delete vehicle information. The external agent leaves timestamp 32 coincident with the time the configuration file 14 was updated.

Datacenter software 16 polls the timestamp 32 of the configuration file 14 to determine if the configuration file 14 has a newer timestamp 32 than what was previously seen. If it is determined that the timestamp 32 is indeed newer, the datacenter software 16 reads and reloads the configuration file 14 into VHM memory. Whenever the timestamp 32 is determined to be newer, the configuration file 14 is reloaded.

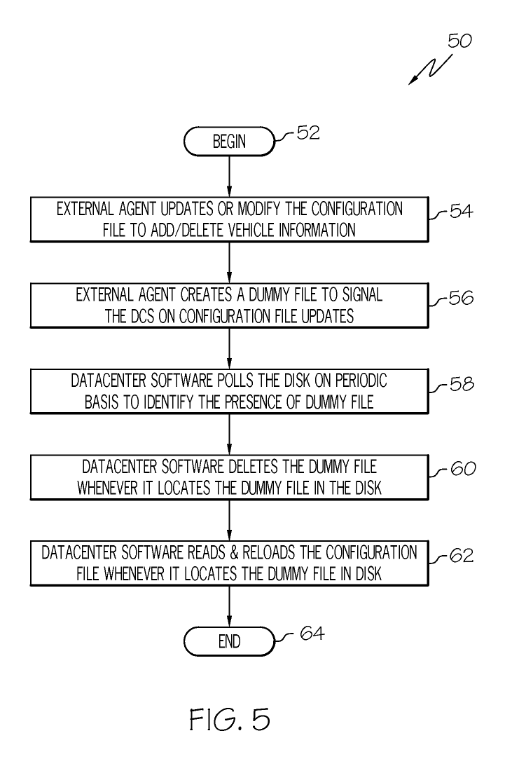

FIGS. 5-8, following, illustrate various exemplary signaling methods for dynamic maintenance of vehicle information for vehicle health maintenance systems. As one skilled in the art will appreciate, various steps in the methods may be implemented in differing ways to suit a particular application. For example, various steps in the methods may be omitted, modified, or may be carried out in differing orders. In addition, various steps may be implemented by differing means, such as by hardware, firmware, or software, or a combination thereof operational on, or associated with, the webservice architecture. For example, the methods may be embodied in computer program products, such as digital versatile discs (DVDs) compact discs (CDs) or other storage media. The computer program products may include computer readable program code having executable portions for performing various steps as illustrated in the following methods.

FIG. 5, following, illustrates an exemplary method 50 of dummy file-based signaling. Method 50 begins (step 52), with the external agent updating or modifying the configuration file to add/delete vehicle information (step 54). A dummy file is created by the external agent to signal to the datacenter software (DCS) on configuration file updates (step 56).

The datacenter software deletes the dummy file whenever the dummy file is located in the disk (step 60). The datacenter software reads and reloads the configuration file whenever it locates the dummy file in the disk (step 62). The method 50 then ends (step 64).

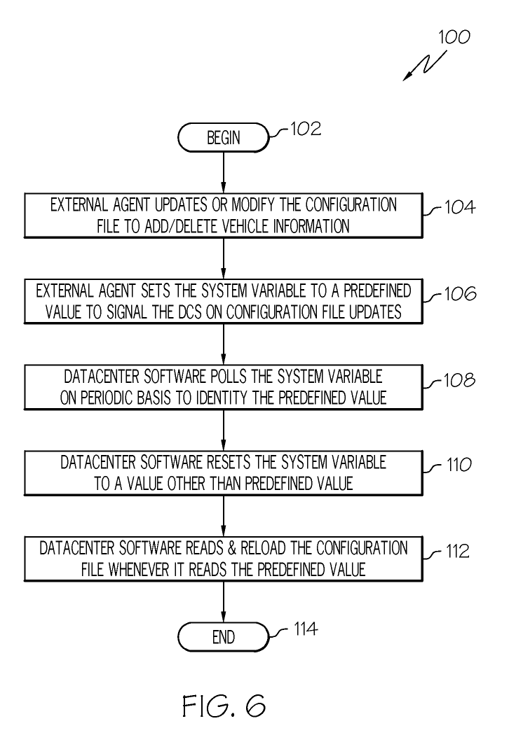

FIG. 6, following, illustrates an exemplary method 100 of system variable-based signaling. Method 100 begins (step 102), with the external agent again updating or modifying the configuration file to add/delete vehicle information (step 104). The external agent sets the system variable to a predefined value to signal the DCS on configuration file updates (step 106).

Datacenter software polls the system variable on periodic basis to identify the predefined value (step 108). Datacenter software resets the system variable to a value other than the predefined value (step 110). Datacenter software reads and reloads the configuration file whenever it reads the predefined value (step 112). The method 100 then ends (step 114).

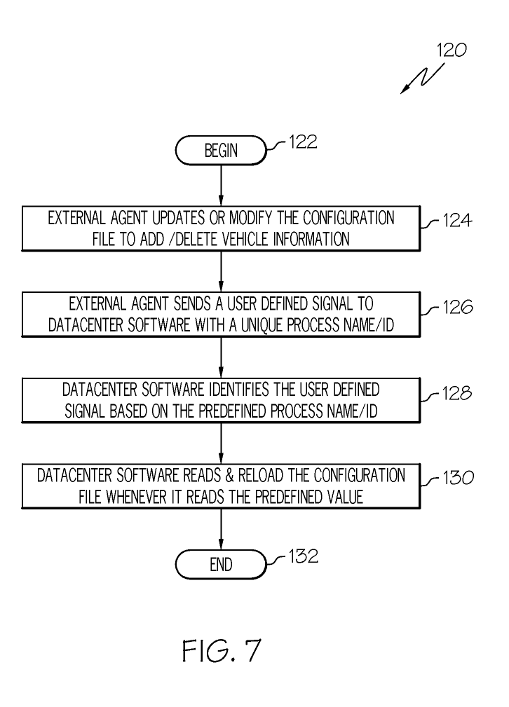

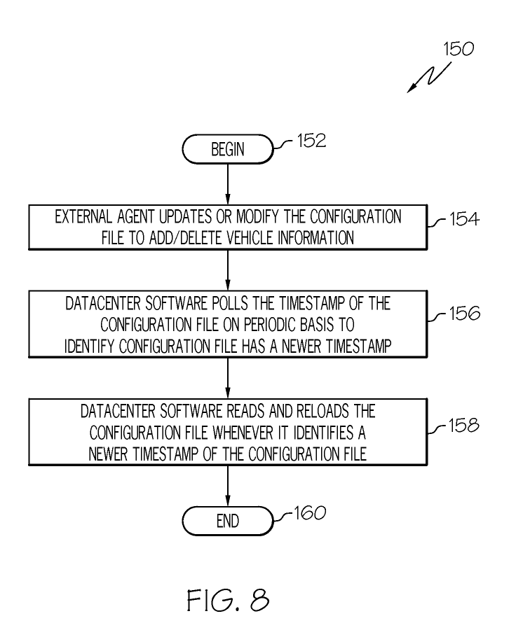

FIG. 7, following, illustrates an exemplary method 120 of user-defined signaling. Method 120 begins (step 122) with the external agent updating or modifying the configuration file to add/delete vehicle information (step 124). The external agent sends a user-defined signal to the datacenter software with a unique process name/ID (step 126).

Datacenter Software identifies the user-defined signal based on the predefined process name/id (step 128). Datacenter software reads and reloads the configuration file whenever it reads the predefined value (step 130). The method 120 then ends (step 132).

FIG. 8, following, illustrates an exemplary method 150 of timestamp-based signaling. Method 150 begins (step 152) with the external agent updating or modifying the configuration file to add/delete vehicle information (step 154). The datacenter software polls the timestamp of the configuration file on a periodic basis to identify that the configuration file has a newer timestamp (step 156). The datacenter software reads and reloads the configuration file whenever it identifies a newer timestamp of the configuration file (step 158). The method 150 then ends (step 160).

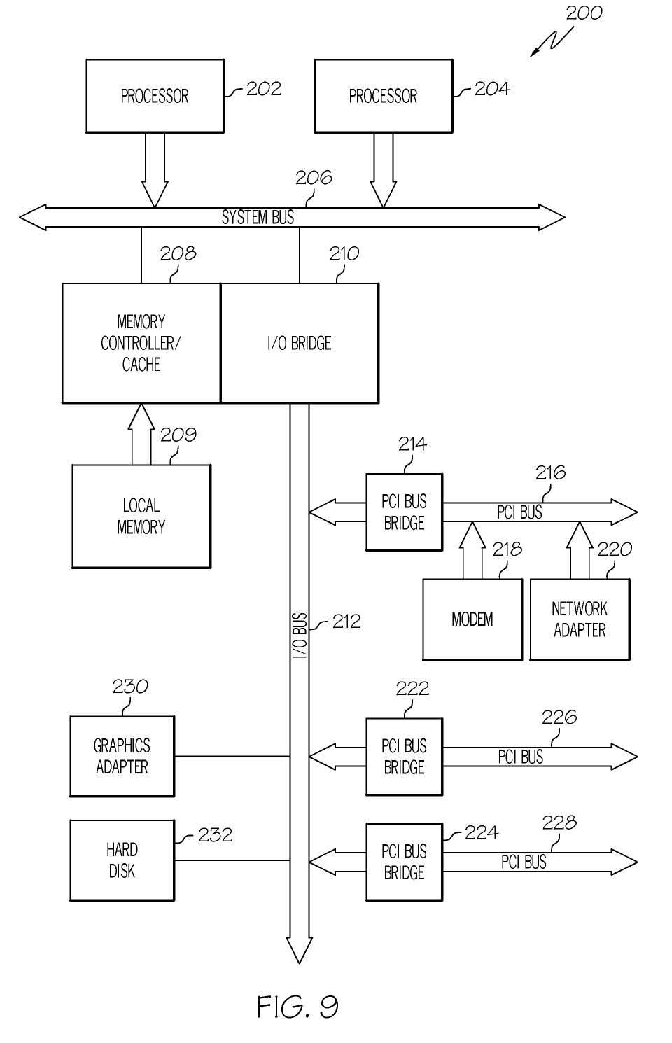

Referring to FIG. 9, a block diagram of an exemplary data processing system 200 is illustrated that may be implemented as a portion of an external agent or datacenter, in accordance with the present description and claimed subject matter. As the skilled artisan will appreciate, the external agent or datacenter software may be operational on, or associated with, data processing system 200 or a similar system. In addition, the configuration file, disk (virtual or physical), dummy file, system variable settings, user-defined signal, and timestamps previously described may also be operational on, or otherwise associated with, system 200. For example, configuration file may reside in local memory 209 or elsewhere.

System 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

A peripheral component interconnect (PCI) bus bridge 214 connected to I/O bus 212 provides an interface to PCI local bus 216. Typical PCI bus implementations will support four PCI expansion slots or add-in connectors. Communications links to a datacenter or an external agent, depending on whether system 200 is a client or server, may be provided through modem 218 and network adapter 220 connected to PCI local bus 216 through add-in connectors. Network adapter 220 may be connected to a local area network (LAN) and/or a wide area network (WAN) such as the world-wide-web (WWW) using a variety of communications protocols as the skilled artisan will appreciate, such as Ethernet.

In the case of system 200 configured as a server (such as in a datacenter implementation), additional PCI bus bridges 222 and 224 provide interfaces for additional PCI local buses 226 and 228, from which additional modems or network adapters may be supported. In this manner, data processing system 200 allows connections to multiple network computers (vehicles). A memory-mapped graphics adapter 230 and hard disk 232 may also be connected to I/O bus 212 as depicted, either directly or indirectly.

Those of ordinary skill in the art will appreciate that the hardware depicted in FIG. 9 may vary. For example, other peripheral devices, such as optical disk drives and the like, also may be used in addition to or in place of the hardware depicted. The depicted example is not meant to imply architectural limitations with respect to the present invention.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

While one or more embodiments of the present invention have been illustrated in detail, the skilled artisan will appreciate that modifications and adaptations to those embodiments may be made without departing from the scope of the present invention as set forth in the following claims.

What is claimed is:

1. A method for dynamically managing data changes to a vehicle health monitoring system (VHM) by a datacenter using an external agent, the external agent operational on, or in communication with, a vehicle, the method comprising:
performing one of updating or modifying a vehicle configuration file to add or delete vehicle information on the vehicle configuration file by the external agent;
creating a dummy file on a disk by the external agent, wherein the dummy file provides a signal to the datacenter that the vehicle information on the vehicle configuration file has changed;
polling the disk periodically by the datacenter to identify a presence of the dummy file;
responsive to identifying the presence of the dummy file, reading the configuration file into VHM memory by the datacenter.

2. The method of claim 1, further including notifying a user by the datacenter that the configuration file has changed.

3. The method of claim 1, wherein the performing one of updating or modifying the vehicle configuration file is performed by a first application.

4. The method of claim 3, wherein the polling the disk periodically by the datacenter to identify the presence of the dummy file is performed by a second application.

5. The method of claim 1, wherein the performing one of updating or modifying the vehicle configuration file is performed by the external agent at a local site to the datacenter at a remote site.

6. A method for dynamically managing data changes to a vehicle health monitoring system (VHM) by a datacenter using an external agent, the external agent operational on, or in communication with, a vehicle, the method comprising:
performing one of updating or modifying a vehicle configuration file by the external agent to add or delete vehicle information on the vehicle configuration file;
setting a system variable to a predefined value by the external agent, wherein the predefined value of the system variable provides a signal to the datacenter that the vehicle information on the vehicle configuration file has changed;
polling the system variable periodically by the datacenter to identify the predefined value;
responsive to identifying the predefined value, reading the configuration file into VHM memory by the datacenter.

7. The method of claim 6, further including notifying a user by the datacenter that the configuration file has changed.

8. The method of claim 6, wherein the performing one of updating or modifying the vehicle configuration file is performed by a first application.

9. The method of claim 8, wherein the polling the system variable periodically by the datacenter to identify the predefined value is performed by a second application.

10. The method of claim 6, wherein the performing one of updating or modifying the vehicle configuration file is performed by the external agent at a local site to the datacenter at a remote site.

11. A method for dynamically managing data changes to a vehicle health monitoring system (VHM) by a datacenter using an external agent, the external agent operational on, or in communication with, a vehicle, the method comprising:
performing one of updating or modifying a vehicle configuration file by the external agent to add or delete vehicle information on the vehicle configuration file;
sending a user-defined signal from the external agent to the datacenter, wherein the user-defined signal includes at least one of a unique process name and identification;
receiving the user-defined signal in the datacenter, wherein the datacenter identifies the user-defined signal based on the at least one unique process name and identification; and
responsive to receiving the user-defined signal in the datacenter, reading the configuration file into VHM memory.

12. The method of claim 11, further including notifying a user by the datacenter that the configuration file has changed.

13. The method of claim 11, wherein the performing one of updating or modifying the vehicle configuration file is performed by a first application.

14. The method of claim 13, wherein the receiving the user-defined signal is performed by a second application.

15. The method of claim 11, wherein the performing one of updating or modifying the vehicle configuration file is performed by the external agent at a local site to the datacenter at a remote site.

16. A method for dynamically managing data changes to a vehicle health monitoring system (VHM) by a datacenter using an external agent, the external agent operational on, or in communication with, a vehicle, the method comprising:
performing one of updating or modifying a vehicle configuration file by the external agent to add or delete vehicle information on the vehicle configuration file, wherein a timestamp is recorded on the vehicle configuration file concurrent with the one of updating or modifying the vehicle configuration file;
polling the timestamp periodically by the datacenter to identify a newer time associated with the timestamp; and
responsive to identifying the newer time, reading the configuration file into VHM memory.

17. The method of claim 16, further including notifying a user by the datacenter that the configuration file has changed.

18. The method of claim 16, wherein the performing one of updating or modifying the vehicle configuration file is performed by a first application.

19. The method of claim 18, wherein the polling the timestamp periodically by the datacenter is performed by a second application.

20. The method of claim 16, wherein the performing one of updating or modifying the vehicle configuration file is performed by the external agent at a local site to the datacenter at a remote site.
